(19) United States
(12) Patent Application Publication
(10) Pub. No.: US 2010/0030947 A1
(43) Pub. Date: Feb. 4, 2010

(54) HIGH-SPEED SOLID STATE STORAGE SYSTEM

(76) Inventors: Yang Gi MOON, Ichon-si (KR); Dae Hee YI, Seoul (KR)

Correspondence Address: LADAS & PARRY LLP, 224 SOUTH MICHIGAN AVENUE, SUITE 1600, CHICAGO, IL, 60604, US

(21) Appl. No.: 12/344,781

(22) Filed: Dec. 29, 2008

(30) Foreign Application Priority Data
Jul. 29, 2008 (KR) 10-2008-0073870

(51) Int. Cl. G06F 12/00; G06F 12/02; G06F 12/06

(52) U.S. Cl. 711/103; 711/104; 711/E12.001; 711/E12.008; 711/E12.078

(57) ABSTRACT

A solid state storage device includes a main memory cell array and a sub-memory area. The main memory cell array stores data in a flash memory, whereas the sub-memory includes a non-volatile random access memory for storing data. The data storage speed of the non-volatile random access memory of the sub-memory area is faster than the data storage speed of the flash memory of the main memory cell area. The sub-memory area of the solid state storage device also stores address mapping information therein, so that the address mapping information does not have to be transferred to the main memory cell area and a portion of the main memory cell area does not have to be designated for a non-volatile memory for storing the address mapping information.

### CROSS-REFERENCES TO RELATED APPLICATION

The present application claims priority under 35 U.S.C. §119(a) to Korean patent application number 10-2008-0073870, filed on Jul. 29, 2008, in the Korean Intellectual Property Office, which is incorporated herein by reference in its entirety as if set forth in full.

### BACKGROUND OF THE INVENTION

The present invention relates generally to a solid state storage system, and more particularly, to a high-speed solid state storage system.

In general, non-volatile memories have been used as memories for portable information apparatuses. Recently, solid state drives (SSD) using a NAND flash memory have gained in popularity for use in a PC as an alternative to using simply a hard disk drive (HDD). SSD is considered to have great potential for making inroads in areas of use traditionally considered as limited to HDDs.

In a solid state storage system, such as the SSD, a software layer called a flash translation layer (FTL) is generally used. For example, an FTL is a layer that makes flash memory appear to the system like a disk drive. When using a flash memory, the FTL abstractly shows a flash memory storage device as a group of the same sectors as a disk, and provides read and write (overwrite) operations on logical sectors.

FIG. 1 is a block diagram of a solid stage storage system 1 according to the related art.

Referring to FIG. 1, the solid state storage system 1 includes a host interface 10, a memory controller 20, a micro control unit (MCU) 30, and a memory area 40.

The host interface 10 is connected to the memory controller 20 and transmits and receives control commands, address signals, and data signals between an external host (not shown) and the memory controller 20.

The memory controller 20 selects a predetermined NAND flash memory element (not shown) from a plurality of NAND flash memory elements in the memory area 40, and provides write, delete, and read commands. A first buffer unit 25 is provided in the memory controller 20 and temporarily stores meta data, such as mapping information between logical addresses and physical addresses, as reference information while various operations are performed. The first buffer unit 25 typically uses a static random access memory (SRAM) for storage.

The MCU 30 transmits/receives control commands, address signals, and data signals to/from the memory controller 20. A second buffer unit 35 is provided in the MCU 30. The second buffer unit 35 updates meta data of the memory area 40 and provides the updated meta data to the first buffer unit 25 in the memory controller 20. The second buffer unit 35 typically uses a static random access memory (SRAM) for storage.

The memory area 40 is controlled by the memory controller 20; and write, delete, and read operations of data are performed in the memory area 40. Meanwhile, the updated meta data of the first and second buffer units 25 and 35 is stored in a partial area 45 of the memory area 40, and the partial area 45 is a non-volatile area. After a power supply device is turned on, the meta data as offset information that is required for the operation can be referred to.

The memory area 40 is a NAND flash memory area. An example of a method of managing blocks in the memory area 40 is a log block mapping method. In the log block mapping method, memory blocks are divided into data blocks and log blocks, and address mapping is controlled using the FTL. As is well known, in the log block mapping method, a data block designated according to a logical address is allocated as a log block through mapping and data is stored. Examples of the log block mapping method include an in-place method where designated locations can overlap, and an out-of-place method where designated locations do not overlap. The log block mapping using the out-of-place method will be described herein.

FIG. 2 is a conceptual block diagram of an address mapping process and a storage process according to the related art. Referring to FIGS. 1 and 2, the address mapping process operation will be described.

As described above, the memory blocks in the memory area 40 include log blocks and data blocks (not shown).

When referring to FIG. 2 and the description below, it is assumed that data is written according to logical addresses LB2, LB3, LB1, and LB0. First, a log block is allocated according to the logical address LB2 and then data is stored. The mapping information is updated by the first and second buffers 25 and 35 and is temporarily stored in the first and second buffers 25 and 35. The updated information needs to be stored again in the partial area (refer to reference numeral 45 of FIG. 1) of the memory area 40. The write process according to the logical address LB3 is the same as the just-described write process. When all of the log blocks are allocated, data is merged into a new block.

At this time, it is assumed that the data write time in the memory area 40 after a write request is input is Δt1. Thus, Δt1 is a write time in a log block in a flash memory cell area.

As described above, since the log block uses flash memory in the memory area 40, the write busy time can become long. For example, a write busy time is known as typically being 250 μs in the case of a single level cell (SLC), and the write busy time is known as typically being 850 μs in the case of a multi level cell (MLC). Accordingly, a predetermined write time is required whenever a write request is input. It can be appreciated that a long Δt1 time is necessary as a consequence of the write busy time.

As such, whenever an external request is input, data is stored in an allocated log block of the NAND flash memory after the predetermined time passes, and thus a long write time occurs as a result. Since the updated meta data is stored in the partial area 45 when each command is executed, operations relating to updating and storing of address map information can be complicated and can require a long time.

The lengthy time required when block mapping is processed and data is stored deteriorates the performance of the system. Also, when a portion of the memory area (refer to reference numeral 40 of FIG. 1) is allocated for storing mapping information, the area efficiency of the memory area 40 becomes lower.

### SUMMARY OF THE INVENTION

An embodiment of the invention includes a solid state storage system that can operate at a high speed and improve the area efficiency of a memory area.

According to an aspect of the invention, there is provided a solid state storage system that with memory blocks divided into data blocks and log blocks. The solid state storage system includes a main memory cell array that includes the data blocks; and a sub-memory area that includes log blocks corresponding to the data blocks. A data storage speed in the sub-memory area is faster than a data storage speed in the main memory cell array.

According to another embodiment of the invention, a solid state storage system includes a main memory cell array that includes flash memory; a sub-memory area that includes a plurality of non-volatile random access memories; and a controller that controls mapping of logical addresses and physical addresses of the sub-memory area and the main memory cell array. When a write operation is requested, data is written in the sub-memory area according to a control signal from the controller, and the corresponding address mapping information is stored in the sub-memory area.

According to the embodiments of the invention, since a log block for processing data is allocated using a non-volatile memory cell located outside of a main memory area, the data write time can be reduced. Since it is not necessary to allocate an additional portion of a main memory area for storing address mapping information, restricted resources can be efficiently used.

### BRIEF DESCRIPTION OF THE DRAWINGS

FIG. 1 is a conceptual block diagram of a solid state storage system according to the related art;

FIG. 2 is a block diagram shown for illustrating the data write process for the related art solid state storage system of FIG. 1;

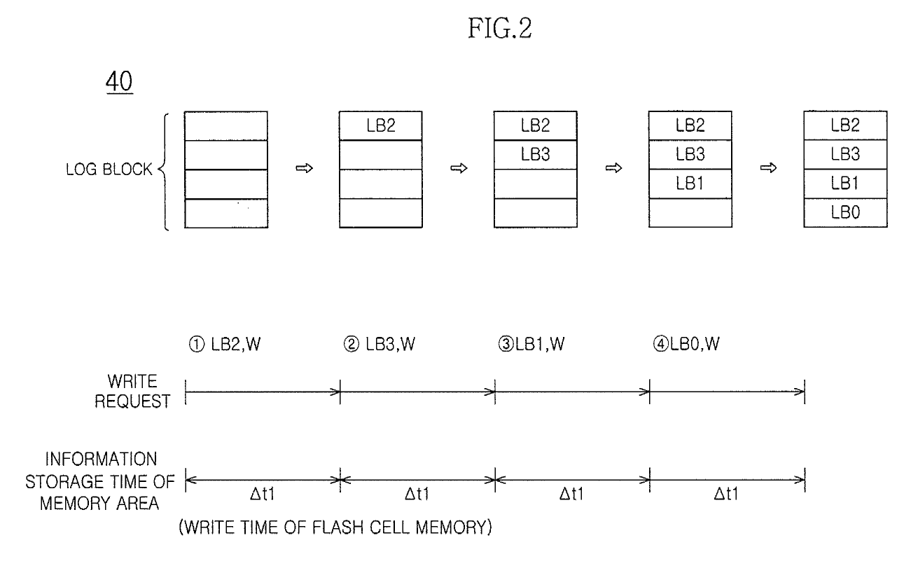

FIG. 3 is a block diagram showing a solid state storage system according to an embodiment of the present invention;

FIG. 4 is a block diagram showing an embodiment of the sub-memory area of the solid state storage system shown in FIG. 3; and

FIG. 5 is a conceptual block diagram shown for illustrating an embodiment of the data write process of the solid state storage system of FIG. 3.

### DESCRIPTION OF EXEMPLARY EMBODIMENTS

Hereinafter, a solid state storage system according to an embodiment of the present invention will be described with reference to the accompanying drawings.

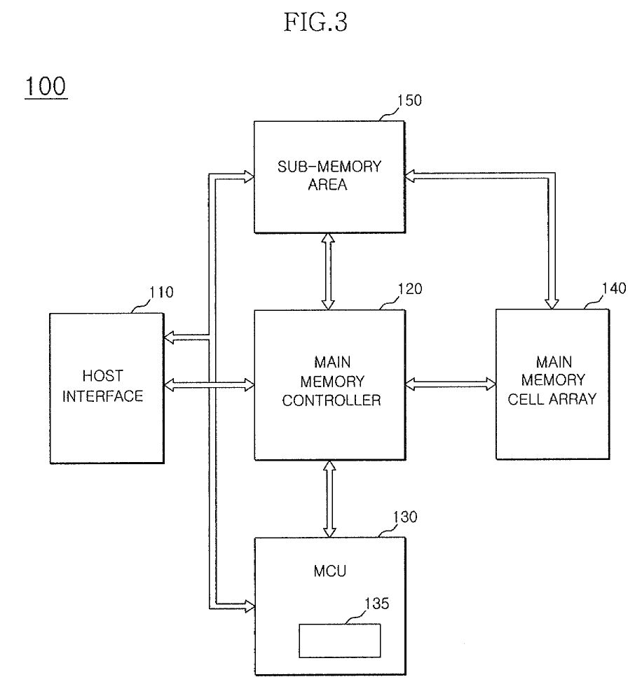

FIG. 3 is a block diagram showing a solid state storage system 100 according to an embodiment of the present invention.

Referring to FIG. 3, the solid state storage system 100 includes a host interface 110, a main memory controller 120, a micro control unit (MCU) 130, a main memory cell array 140, and a sub-memory area 150.

The host interface 110 is connected to the main memory controller 120, and transmits and receives control commands, address signals, and data signals between an external host (not shown) and the memory controller 120. The interface technique for data transfer between the host interface 110 and the external host (not shown) can be, for example, any one of a serial advanced technology attachment (SATA) method, a parallel advanced technology attachment (PATA) method, an SCSI method, a method using an express card, and a PCI-Express method, but the invention is not limited thereto.

According to one embodiment of the present invention, the host interface 110 is connected to the sub-memory area 150, and transmits and receives control commands, address signals, and data signals to/from the sub-memory area 150.

The main memory controller 120 selects a predetermined NAND flash memory element (not shown) from a plurality of NAND flash memory elements included in the main memory cell array 140, and provides write, delete, and read commands.

The MCU 130 transmits and receives control commands, address signals, and data signals to/from each of the main memory controller 120 and the sub-memory area 150 or controls the main memory controller 120 and the sub-memory area 150 using the above signals. The MCU 130 includes a buffer unit 135, and the buffer unit 135 updates meta data of the main memory cell array 140 or the sub-memory area 150 and stores the meta data.

The main memory cell array 140 is controlled by the main memory controller 120; and write, delete, and read operations of data are performed in the memory cell array 140.

The sub-memory area 150 according to an embodiment of the present invention functions as a log block that processes data from the main memory cell array 140.

More specifically, the sub-memory area 150 is controlled by control signals from the host interface 110 and the MCU 130, and allocates a log block corresponding to a data block (not shown) when a write operation is requested and stores data. In an embodiment of the present invention, the sub-memory area stores and updates data more preferentially than the data blocks.

According to an embodiment of the present invention, the sub-memory area 150 includes non-volatile random access memory.

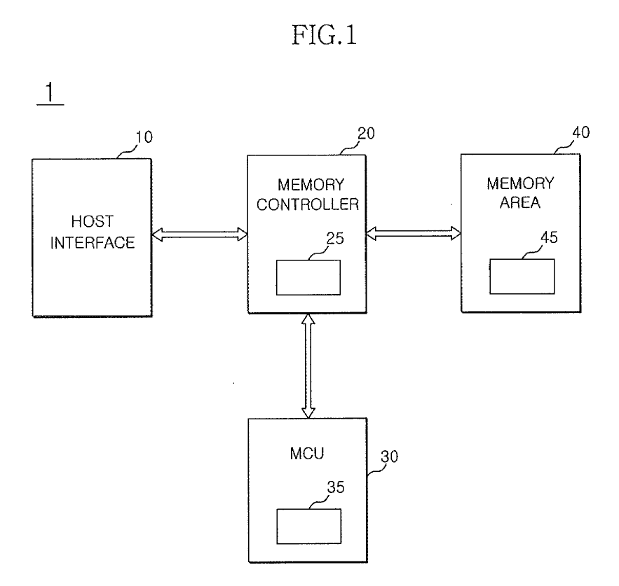

When a write operation is requested by the external host (not shown), the sub-memory area 150 allocates a log block using the non-volatile random access memory in the sub-memory area 150 and stores data in the non-volatile random access memory. Thus, for example, the data storage speed of the device can be increased when compared to the related art, since in the embodiment of the present invention, the log blocks are allocated using non-volatile random access memory contained in a sub-memory area 150, whereas in the related art, data is stored in an allocated log block of a NAND flash memory of the memory area 40 (as shown in FIG. 1).

As is known, the data write time of a non-volatile random access memory can generally be considered to be in the range of 30 to 50 ns. Thus, when data is stored in the sub-memory area 150, the data can be stored in a shorter period of time than the write busy time (generally 250 μs or 850 μs) of the flash memory of the related art. Since the sub-memory area 150 is non-volatile RAM, data is not lost even when the power supply of the device is turned off, and also the updated meta data can be stored in the sub-memory area 150 rather than, for example, a partial area of the memory area 40 (see FIG. 1). That is, meta data does not need to be stored in a partial area of the main memory cell array 140; however, the device according to embodiments of the present invention is able to retain the ability to refer to the updated meta data even after the power supply device has been turned off and then turned on, since the sub-memory area 120 utilizes non-volatile memory.

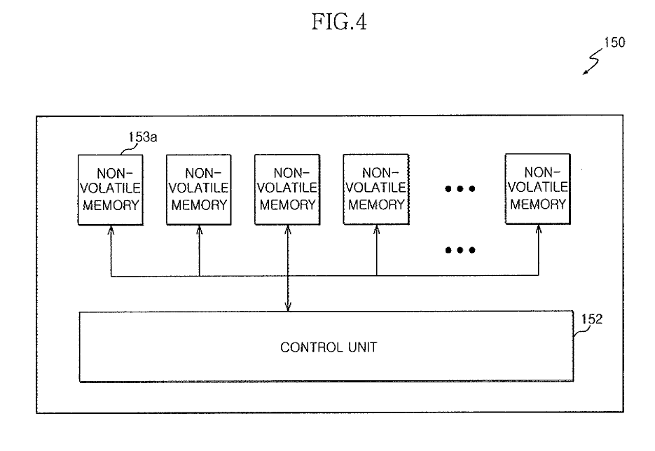

FIG. 4 is a block diagram showing an embodiment of the sub-memory area 150 shown in FIG. 3.

Referring to FIG. 4, the sub-memory area 150 includes a control unit 152 and a plurality of non-volatile memories 153a.

The control unit 152 controls the operation of the non-volatile memories 153a in response to a command signal from the is host interface (refer to reference numeral 110 of FIG. 3).

For example, when the host interface (refer to reference numeral 110 of FIG. 3) requests the performance of a write operation, the control unit 152 selects any one of the plurality of non-volatile memories 153a, allocates the non-volatile memory as a log block, and controls a write operation.

The plurality of non-volatile memories 153a are controlled by the control unit 152 and operate as working memories when a write operation is performed. At this time, since the data write speed of the non-volatile memory 153a is faster than the data write speed of the flash memory, the data storage speed can be increased.

Since the non-volatile memory 153a can maintain information even when the power supply is turned off, it is not necessary to perform a process of storing the information in the main memory cell array 140 to manage the meta data. Examples of the non-volatile memory include a ferroelectric RAM (FeRAM), a magnetic RAM (MRAM), and a phase-change RAM (PRAM).

The FeRAM can store data by taking advantage of the properties of the ferroelectric material of the device.

The PRAM can, for example, store data by arbitrarily setting a “state” of the data to correspond to a crystalline phase in which the resistance of a specific material is relatively low and to correspond to an amorphous phase in which the resistance of the specific material is relatively high, where the phase of the specific material can be changed by applying current to the specific material.

The MRAM can store data using a ferromagnetic material and by taking advantage of the properties of a magnetic field of the device, that is, properties of N and S poles.

As described above, in the non-volatile memories, even when the power supply device is turned off, the information stored in the memories can be maintained without having continual power, and a data write speed is faster than that of the flash memory cell. Therefore, the operation of the semiconductor storage system according to an embodiment of the present invention can be performed at a high speed.

Meanwhile, the non-volatile memory 153a is exemplified as a next-generation non-volatile memory. For example, an EEPROM having a data write speed faster than that of a flash memory cell can be used as the non-volatile memory 153a.

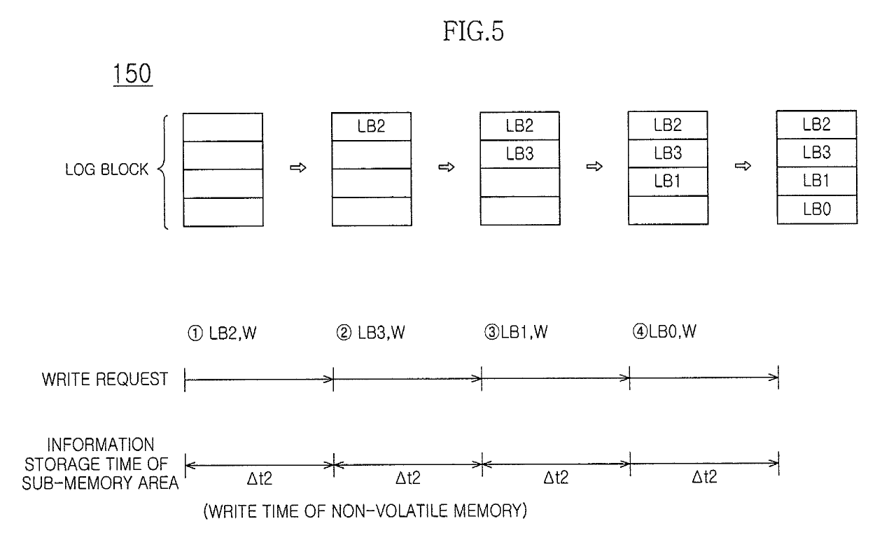

FIG. 5 is a conceptual block diagram of an address mapping process and a storing process of semiconductor storage system of FIG. 3.

Referring to FIG. 5, certain aspects of the address mapping process will be described in detail.

Whenever a write request is provided by the external host, log blocks are allocated according to logic addresses LB2, LB3, LB1, and LB0, and mapping information is updated. That is, a log block is allocated in the non-volatile memory (refer to reference numeral 153a of FIG. 4) by the logic address LB2 and data is stored at a high speed. At this time, since the meta data, such as the updated mapping information, is also stored in the non-volatile memory (refer to reference numeral 153a of FIG. 4), the meta data is maintained even when the power supply is turned off. Accordingly, the extra time necessary for transmitting the meta data information to a specific area and storing the meta data in the specific area is not required.

The data and the updated meta data are stored in the sub-memory area 150 after the write operation is performed according to the external request. At this time, it is assumed that data storage time of the non-volatile memory (refer to reference numeral 153a of FIG. 4) is Δt2. Since Δt2 is determined by the write speed of the non-volatile memory 153a, the write time in the non-volatile memory cell area can be in a range of 30 to 50 ns.

That is, since the data is written and the updated meta data is stored in the non-volatile memory area according to an embodiment of the present invention, the operation completion speed of the data process operation can be increased when receiving a write request. According to an embodiment of the present invention, a portion of the main memory cell array (refer to reference numeral 140 of FIG. 3) for storing the meta data does not need to be allocated, different from the related art. Accordingly, it is possible to improve the area efficiency of the main memory cell array (refer to reference numeral 140 of FIG. 3), which is allocated as main memory space.

When all of the requested write data is allocated to the non-volatile memories 153a in the sub-memory area 150, the data can be substituted by the data in the main memory cell array 140 or can be merged into the data of the main memory cell array 140.

As such, according to embodiments of the present invention, since a log block for performing the write operation is allocated to a non-volatile memory, the data storage speed can be improved. In addition, since the updated meta data can be stored using the non-volatile memory, operation can be easily controlled and the operation speed can be increased. Accordingly, the write operation can be performed at a high speed, using the non-volatile memory having a data processing speed faster than the data processing speed of the flash memory in the manner described above.

While certain embodiments have been described above, it will be understood that the embodiments described are by way of example only. Accordingly, the systems and methods described herein should not be limited based on the described embodiments. Rather, the systems and methods described herein should only be limited in light of the claims that follow when taken in conjunction with the above description and accompanying drawings.

What is claimed is:

1. A solid state storage system having memory blocks divided into data blocks and log blocks, comprising:
a main memory cell array comprising the data blocks; and
a sub-memory area comprising the log blocks, wherein the log blocks correspond to the data blocks,
wherein a data storage speed of the sub-memory area is faster than a data storage speed of the main memory cell array.

2. The solid state storage system of claim 1,
wherein the sub-memory area stores and updates data more preferentially than the data blocks.

3. The solid state storage system of claim 1,
wherein the sub-memory area comprises a non-volatile random access memory (NVRAM).

4. The solid state storage system of claim 31
wherein the non-volatile random access memory includes any one of a ferroelectric RAM (FeRAM), a magnetic RAM (MRAM), and a phase-change RAM (PRAM).

5. The solid state storage system of claim 1, wherein when data is written to any one of the log blocks, address mapping information corresponding to the data written to the any one of the log blocks is stored in the sub-memory area.

6. The solid state storage system of claim 1, wherein the sub-memory area comprises a plurality of non-volatile random access memories each having a data storage speed faster than that of the main memory cell array.

7. The solid state storage system of claim 6, wherein the sub-memory area comprises a control unit configured to control the respective non-volatile random access memories such that requested write data is stored in any one of the non-volatile random access memories.

8. The solid state storage system of claim 1, wherein when each of a predetermined number of write spaces in the sub-memory area are allocated in the sub-memory area, the predetermined number of write spaces are substituted with write spaces of the main memory cell array.

9. A solid state storage system, comprising:
a main memory cell array comprising flash memory;
a sub-memory area comprising non-volatile random access memory; and
a controller that controls mapping of logical addresses and physical addresses of the sub-memory area and the main memory cell array,
wherein, when a write operation is requested, data is written to the sub-memory area according to a control signal from the controller, and address mapping information corresponding to the data written in the sub-memory area is stored in the sub-memory area.

10. The solid state storage system of claim 9,
wherein the nonvolatile memory includes a plurality of non volatile memories, and the sub-memory area further comprises a control unit configured to control the respective non-volatile random access memories.

11. The solid state storage system of claim 9,
wherein the non-volatile random access memory includes any one of an FeRAM, an MRAM, and a PRAM.

12. The solid state storage system of claim 10,
wherein the control unit is configured to control the plurality of non-volatile random access memories in response to the control signal from the controller, such that requested write data and the address mapping information corresponding to the requested write data are stored in any one of the non-volatile random access memories.

13. The solid state storage system of claim 9,
wherein, when each of a predetermined number of write spaces of the sub-memory area are allocated in the sub-memory area, the controller is configured to perform a control operation, such that the predetermined number of write spaces are substituted with write spaces of the main memory cell array.
